(19) United States
(12) Patent Application Publication
(10) Pub. No.: US 2004/0108979 A1
(43) Pub. Date: Jun. 10, 2004

(54) Driving device of active type light emitting display panel

(75) Inventor: Shuichi Seki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 10/694,356

(22) Filed: Oct. 28, 2003

(30) Foreign Application Priority Data
Oct. 29, 2002 (JP) 2002-314062

(51) Int. Cl. G09G 3/30

(52) U.S. Cl. 345/76

(57) ABSTRACT

In order to provide, as a lighting means for a pixel including a driving TFT and an EL element, a driving device of a light emitting display panel which can dissolve respective technical problems which occur in cases where respective constant voltage driving and constant current driving techiniques are adopted, a light emitting power holding capacitor C2 is connected in series to the driving TFT (Tr2) and the EL element E1. A diode D1 for charging electrical charges in the capacitor C2 and a switching element SW2 for supplying current to the diode D1 are provided. By an ON operation of the switching element SW2 both ends of the capacitor C2 is subjected to a charge operation so as to become equipotentials. By an OFF operation of the switching element SW2, driving current flows in the EL element E1 via the driving TFT (Tr2). The amount of current flowing in the EL element E1 is controlled by the repeat frequency of ON/OFF of the switching element SW2.

### BACKGROUND OF THE INVENTION

1. Field of the Invention

The present invention relates to a driving device of a light emitting display panel in which a light emitting element constituting a pixel is actively driven by a TFT (thin film transistor) and particularly to a driving device of a light emitting display panel in which improvement is made to a driving power supplying means for supplying driving power to a light emitting element.

2. Description of the Related Art

A display using a display panel in which light emitting elements are arranged in a matrix pattern has been developed widely. As a light emitting element employed in such a display panel, an organic EL (electro-luminescent) element in which an organic material is employed in a light emitting layer has attracted attention. This is because of backgrounds one of which is that by employing, in a light emitting layer of an EL element, an organic compound which enables an excellent light emitting characteristic to be expected, a high efficiency and a long life have been achieved which make an EL element satisfactorily practicable.

As display panels in which such organic EL elements are employed, a simple matrix type display panel in which EL elements are simply arranged in a matrix pattern and an active matrix type display panel in which an active element consisting of a TFT is added to each of EL elements arranged in a matrix pattern have been proposed. The latter active matrix type display panel can realize low power consumption, as compared with the former simple matrix type display panel, and has characteristics such as less cross talk between pixels and the like, thereby being specifically suitable for a high definition display constituting a large screen.

FIG. 1 shows a most basic circuit configuration corresponding to one pixel 11 in a conventional active matrix type display device, which is called a conductance control technique. In FIG. 1, a gate of a controlling TFT (Tr1) comprised of N-channels is connected to a scan line extending from a scan driver 12, and its source is connected to a data line extending from a data driver 13. A drain of the controlling TFT (Tr1) is connected to a gate of a driving TFT (Tr2) comprised of P-channels and to one terminal of a capacitor C1 provided for holding electrical charges.

A source of the driving TFT (Tr2) is, on the other hand, connected to the other terminal of the capacitor C1 and to a power supply (VDD) supplying a driving current to an EL element E1 provided as a light emitting element. A drain of the driving TFT (Tr2) is connected to an anode of the EL element FL1, and a cathode of this EL element is connected to, for example, a reference potential point (a ground). A large number of pixels 11 of this structure are arranged in a matrix pattern so as to form a light emitting display panel.

When an ON controlling voltage (Select) is supplied to the gate of the controlling TFT (Tr1) shown in FIG. 1 via the scan line, the controlling TFT (Tr1) allows current which matches a data voltage (Vdata) supplied from the data line to the source to flow from the source to the drain. Therefore, during the period when the gate of the controlling TFT (Tr1) is at an ON voltage, the capacitor C1 is charged, and the capacitor's voltage is supplied to the gate of the driving TFT (Tr2). Thus, by a drain current of the driving TFT (Tr2) based on this voltage, the EL element is driven so that the EL element emits light.

When the gate of the controlling TFT (Tr1) becomes an OFF voltage, the controlling TFT (Tr1) becomes, namely, a cutoff, and the drain of the controlling TFT (Tr1) becomes an open state. The gate voltage of the driving TFT (Tr2) is, however, maintained by electrical charges accumulated in the capacitor C1, the driving current is maintained until a next scan, and the light emission of the EL element E1 is also maintained.

As a driving means for the pixel 11 constructed as shown in FIG. 1, a constant voltage driving or a constant current driving can be adopted. In the case where the former constant voltage driving is adopted, Vdata given from the data driver 13 is written in the capacitor C1 via the controlling TFT (Tr1), and the Vdata written in this capacitor C1 is applied to the gate of the driving TFT (Tr2). At this time, the driving TFT (Tr2), in a sense, functions as a switch, in response to Vdata written in the capacitor C1, and the driving current (drain current) ID supplied to the EL element E1 is controlled by a voltage value supplied from the power source (VDD).

The EL element E1, on the other hand, has a diode component and parasitic capacitance which is parallel to the diode component, and it has been known that in the state where a voltage which is an EL element's light emission threshold voltage or greater is applied to the EL element, the EL element emits light whose intensity is approximately proportional to the forward current of the EL element. It has been also known that the forward voltage (VF) of the EL element E1 changes when the EL element is affected by changes with time and an operating temperature. Therefore, in the case where the EL element is driven by a constant voltage as mentioned above, the drain current ID is changed based on the change in the forward voltage (VF), and as a result, a problem that the light emission intensity of the EL element E1 changes is caused.

In the case where the latter constant current driving is adopted as the driving means of the pixel 11, Vdata given from the data driver 13 is written in the capacitor C1, and the drain current ID of the driving TFT (Tr2) is controlled based on the value of Vdata written in this capacitor C1. In the case where this constant current driving is adopted, although the problem that the light emission intensity changes in response to changes in the forward voltage (VF) can be prevented, variations in the threshold voltage (Vth) of the driving TFT (Tr2) are relatively large, and this yields variations to the drain current ID. As a result, light emission intensities change individually, and a problem that nonuniformity in intensity among pixels occurs is caused.

In order to solve the above-described problems to some extent, lighting driving means for an EL element such as a voltage writing technique, a current writing technique, a current mirror technique, or the like has been proposed. The voltage writing technique and the current writing technique which include the above-mentioned conductance control technique are disclosed, for example, in Non-patent Reference 1 shown below, and the current mirror technique in Patent Reference 1.

FPD technology encyclopedia 2001

, pp. 753 to 757.

Japanese Patent Application Laid-Open No. 2002-156923 (e.g., FIG. 7).

Meanwhile, in the case where a lighting driving means for an EL element such as the above-mentioned voltage writing technique, current writing technique, the current mirror technique is adopted, a problem that the number of TFTs constituting one pixel becomes large occurs, and a problem that arrangement of signal lines for controlling these TFTs and a peripheral circuit become complex and the like occurs.

### SUMMARY OF THE INVENTION

The present invention has been developed in view of the above-described technical problems, and it is an object to provide a driving device of an active type light emitting display panel in which changes in the light emission intensity of an EL element based on a temperature dependency or on changes with time and further nonuniformity in intensity among pixels based on variations in threshold voltages of driving TFTs can be effectively reduced.

A driving device of a light emitting display panel according to the present invention which has been developed to solve the above-described problems is, as described in claim 1, a driving device driving an active type light emitting display panel in which a large number of light emitting pixels are arranged each of which is comprised of at least a light emitting element and a driving TFT which lights and drives the light emitting element, and the driving device is characterized by comprising a power supply means for supplying light emitting driving power to the light emitting element by executing charge and discharge operations for a light emitting power holding capacitor.

### BRIEF DESCRIPTION OF THE DRAWINGS

FIG. 1 is a connection diagram showing a circuit structure corresponding to one pixel in a conventional active matrix type display device;

FIG. 2 is a connection diagram of a pixel unit showing a first embodiment in a driving device according to the present invention;

FIG. 3 is timing charts explaining operations in the structure shown in FIG. 2;

FIG. 4 is a connection diagram explaining a connection relationship with peripheral circuits in the case where the structure shown in FIG. 2 is adopted;

FIG. 5 is a connection diagram of a pixel unit showing a second embodiment in a driving device according to the present invention;

Similarly, FIG. 6 is a connection diagram of a pixel unit showing a third embodiment;

FIG. 7 is connection diagrams showing other pixel structure examples to which the present invention can be applied; and

FIG. 8 is a connection diagram showing yet another pixel structure example to which the present invention can be applied.

### DESCRIPTION OF THE PREFERRED EMBODIMENTS

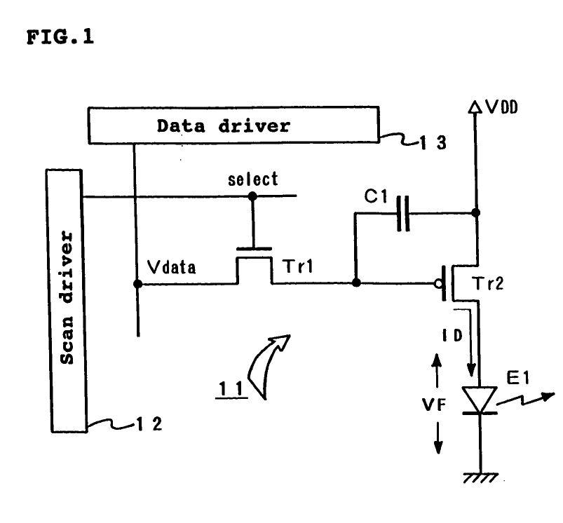

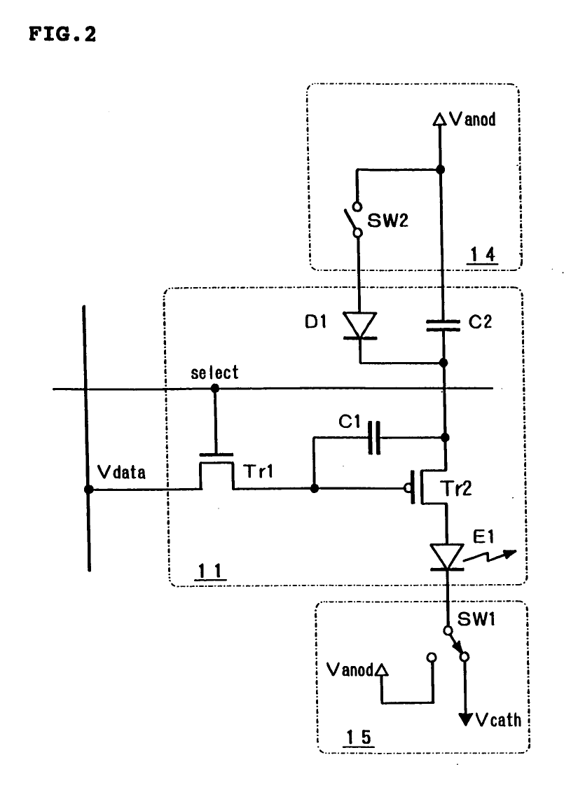

Hereinafter, a driving device of a light emitting display panel according to the present invention will be explained below based on embodiments shown in the drawings. FIG. 2 shows a first embodiment of a driving device including a pixel structure according to the present invention, and a pixel 11 is provided with two TFTs, that is, an N-channel controlling TFT (Tr1) and a P-channel driving TFT (Tr2), similarly to the example shown in FIG. 1. A capacitor C1 for holding electrical charges is connected between a gate and a source of the driving TFT (Tr2), and an anode of an EL element E1 as a light emitting element is connected to a drain of the driving TFT (Tr2), so that a lighting driving circuit by a conductance control technique is constructed.

One terminal of a capacitor C2 provided for holding light emitting power is connected to the source of the driving TFT (Tr2), and the other terminal of this capacitor C2 is connected to a voltage source Vanod constituting an anode side power supply circuit 14. A unidirectional element for charging electrical charges in the capacitor C2, that is, a diode D1, and a switching element SW2 which supplies current to this diode D1 in this embodiment, are connected in series between the source of the driving TFT (Tr2) and the voltage source Vanod.

A cathode of the EL element E1 whose anode is connected to the drain of the driving TFT (Tr2) is, on the other hand, connected to a cathode side power supply circuit 15. A change-over switch SW1 is provided in the cathode side power supply circuit 15, and the cathode of the EL element E1 is alternatively connected to Vcath whose electrical potential is lower than that of the anode side voltage source Vanod or to Vanod of the same electrical potential via the change-over switch SW1.

In this embodiment shown in FIG. 2, the respective light emitting power holding capacitor C2 and diode D1 are provided in one light emitting pixel 11 together with the respective TFTs (Tr1 and Tr2), capacitor C1, and EL element E1, and a large number of pixels 11 with this structure are arranged in a matrix pattern to form a light emitting display panel. The light emitting power holding capacitor C2 and the diode D1 formed in the pixel 11 and the switching element SW2 arranged in the anode side power supply circuit 14 constitute a power supply means for supplying light emission driving power to the EL element E1.

The driving TFT (Tr2) is, on the other hand, constructed so as to be driven as a switching element in response to the data voltage (Vdata) supplied from a data line to its gate via the controlling TFT (Tr1), that is, so as to operate in a nonlinear region. Although it is not shown in FIG. 2, a gate of the controlling TFT (Tr1) is connected to a scan line extending from a scan driver 12 similarly to the example shown in FIG. 1, and a source of the controlling TFT (Tr1) is connected to the data line extending from a data driver 13.

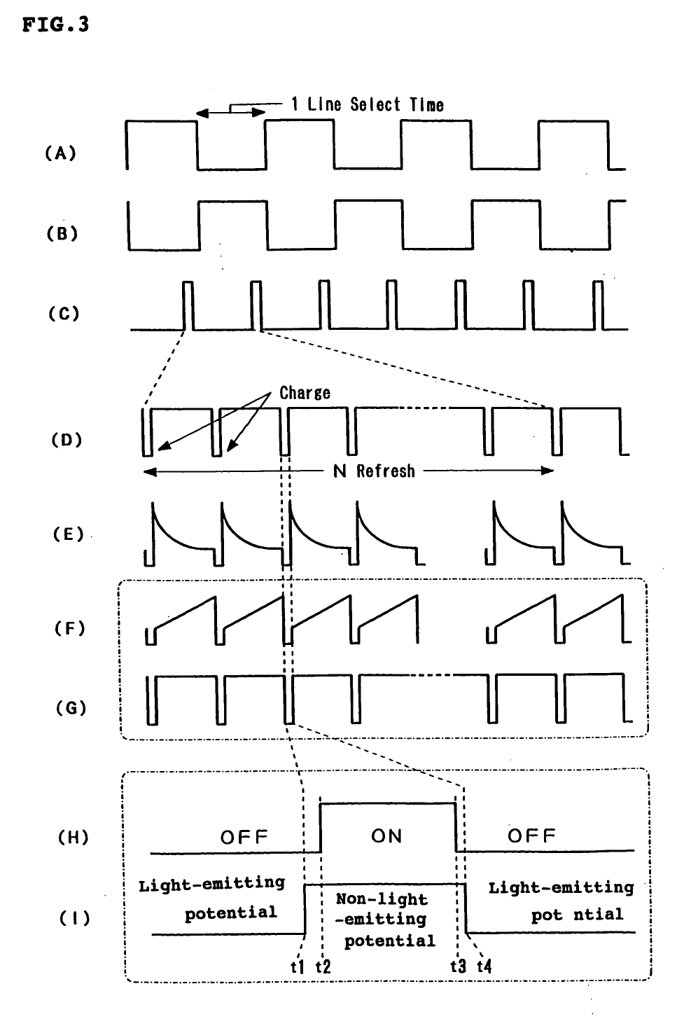

Lighting driving operations of the pixel 11 in the structure shown in FIG. 2 are shown in FIG. 3. (A) shown in FIG. 3 shows a gate clock for shifting up an unillustrated shift resister which is provided in the scan driver 12, and in this embodiment, a reverse clock shown as (B) obtained by reversing the gate clock is utilized. During a generation interval of a latch signal shown in (C) generated in synchronization with the reverse clock (B), that is, during a light emission driving time of the EL element E1 for each scan, at least one or more (═N) charge and discharge operations are performed in the light emitting power holding capacitor C2 constituting the power supply means, and this works so that light emission driving power is supplied to the EL element E1.

(D) shown in FIG. 3 shows a manner in which N charge and discharge operations are performed in the light emitting power holding capacitor C2 during the generation interval of the latch signal, and here, the charge operation of electrical charges in the capacitor C2 is performed at the timing of bottom portions of the signal waveform shown as (D). In this embodiment, the charge operation is also called a refresh operation.

This charge operation (refresh operation) is implemented by ON and OFF operations shown in FIG. 3(H) by the switching element SW2 and by a selection operation of a light-emitting potential and a non-light-emitting potential shown in FIG. 3(I) by the change-over switch SW1. That is, at time t1 shown in (I), changing over from the light-emitting potential to the non-light-emitting potential is performed. This means that functionally the change-over switch SW1 is changed over from a selection state (the light-emitting potential) of Vcath to a selection state (the non-light-emitting potential) of vanod. By this changing over, both end voltages of the EL element E1 become approximately zero, and the EL element E1 is brought into a non-lighting state.

Then, at time t2, as shown in FIG. 3(H), the ON operation of the switching element SW2 is performed. Thus, current from the voltage source Vanod flows toward a connection point between the light emitting power holding capacitor C2 and the driving TFT (Tr2) via the switching element SW2 and the diode D1, and the charge operation for making electrical charges in the capacitor C2 approximately zero is performed. Thus, the electrical charges of the capacitor C2 are refreshed to an approximately zero state.

Then, at time t3 as shown in FIG. 3(H), the OFF operation of the switching element SW2 is performed, and at time t4 immediately thereafter as shown in FIG. 3(I), the change-over switch SW1 returns to the state shown in FIG. 2, that is, to the light-emitting potential. Thus, a forward voltage between the power source Vanod and the power source Vcath is applied to a series circuit of the capacitor C2, driving TFT (Tr2), and EL element E1. Accordingly, a forward current can flow in the EL element E1 via the capacitor C2 whose electrical charges are in the approximately zero state.

At this time, the driving TFT (Tr2) is operating in a nonlinear region as described above, and if the gate voltage of the driving TFT is in an ON state, the forward current flows in the EL element E1, so that the EL element E1 is brought into a lighting state. Thus, a lighting driving current which attenuates according to a quadratic curve as shown in FIG. 3(E) flows in the EL element E1 via the capacitor C2. This becomes an attenuation type current waveform generated since electrical charges of the capacitor C2 change from the zero state to a state in which electrical charges of the capacitor C2 are accumulated. In other words, the above-described operation can also be expressed in such a manner that an operation is performed where from a charged state in which the potential difference at both terminals of the capacitor C2 is in the approximately zero state, the capacitor C2 discharges so that said potential difference approaches the potential difference between Vanod and Vcath.

A lighting operation of the EL element E1 by the driving current shown in FIG. 3(E) is performed one time or more, that is, is repeated N times, in the light emission driving time for each scan. When the number of times of repeating (number of times of refreshing), N, during the light emission driving time for each scan is large, the amount of the driving current flowing in the EL element E1 becomes large, and the light emission intensity of the EL element E1 becomes high approximately in proportion to the amount of the driving current. Thus, by suitably setting the number of times of refreshing, N, it is also possible to control the gradation of the pixel 11 digitally.

With the lighting driving operation of the EL element E1 explained above, the lighting driving current which attenuates according to the quadratic curve as shown in FIG. 3(E) flows in the EL element E1 repeatedly. Thus, it is desired that the driving device is constructed in such a manner that as the supply voltage of when charging current is supplied to the capacitor C2, that is, as the output voltage supplied from the voltage source Vanod, a voltage waveform which sweeps so that the level thereof increases repeatedly as shown in FIG. 3(F) is outputted in synchronization with the charge and discharge operations of the light emitting power holding capacitor C2. In the case where such voltage waveform is adopted, it is possible to allow a constant current as shown in FIG. 3(G) to flow in the EL element E1. Thus, a problem that a driving current including a peak value of a high level as shown in FIG. 3(E) is supplied to the EL element E1 cam be prevented, which can contribute to prolongation of the life of an EL element E1.

With the first embodiment shown in FIG. 2 explained above, the current amount supplied to the EL element E1 can be controlled by execution frequency of the refresh operation for the light emitting power holding capacitor C2. Thus, digital gradation expression can be achieved. At this time, since the driving TFT (Tr2) can be operated in a nonlinear region, it can be prevented that due to variations in threshold voltages (Vth) of driving TFTs, similar variations in driving currents are imparted, and a problem that nonuniformity in intensity among pixels occurs can also be effectively prevented. Thus, respective technical problems which occur in the respective constant voltage driving and constant current driving which have been explained in the section of the prior art can be solved.

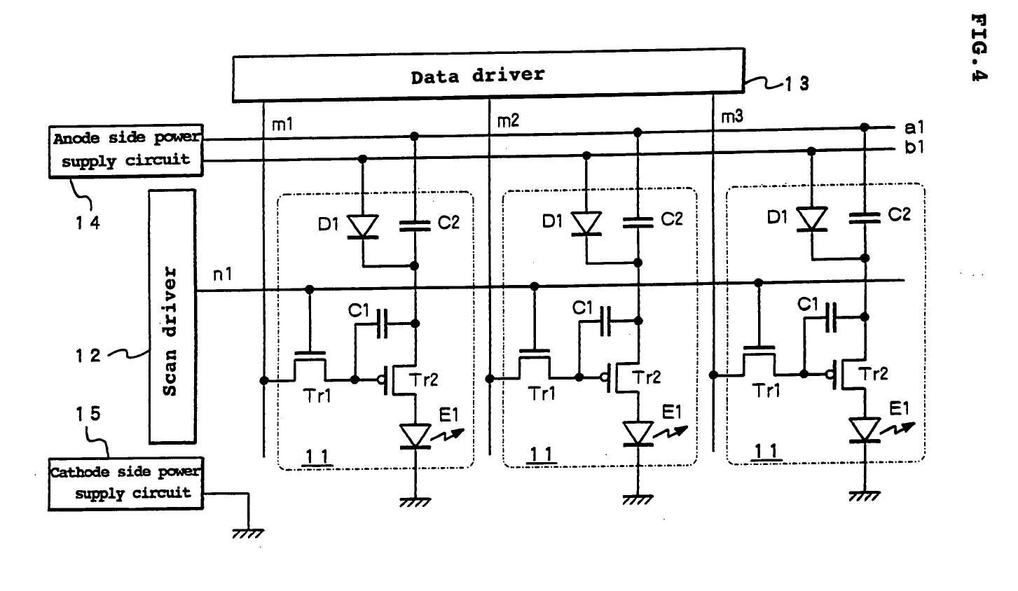

FIG. 4 shows a connection relationship between pixels and peripheral circuits in a display panel in the case where the above-described pixel structure is adopted, and in FIG. 4 an example in which representatively three pixels 11 are arranged is shown. FIG. 4 shows an example in which a single color display panel in which a common driving current is supplied to the respective pixels 11 is constructed. In this example, the respective gates of the controlling TFTs (Tr1) in the respective pixels 11 are connected to a scan line n1 extending from a scan driver 12, and the respective sources of the controlling TFTs (Tr1) in the respective pixels 11 are connected to respective data lines m1, m2, and m3 extending from a data driver 13.

One ends of the light emitting power holding capacitors C2 constituting a part of the pixel 11 and the anodes of the diodes D1 for charging electrical charges in the capacitors C2 are connected to control lines a1 and b1 extending from an anode side power supply circuit 14, respectively. The anode side power supply circuit 14 shown in FIG. 4 is constructed similarly to that shown in FIG. 2, supplies an output voltage supplied from the voltage source Vanod to the control line al, and supplies the output voltage via the switching element SW2 to the control line b1.

Further, in the structure shown in FIG. 4, respective cathodes of the EL elements E1 in the respective pixels 11 are a common cathode at a reference potential point and are connected to a cathode side power supply circuit 15 designated by reference numeral 15 via this reference potential point. The cathode side power supply circuit 15 shown in FIG. 4 is constructed similar to that shown in FIG. 2 and is constructed so that the circuit 15 can alternatively select the electrical potentials of the voltage sources Vcath or Vanod via the change-over switch SW1.

Although the example shown in FIG. 4 shows a structural example of a single color display panel as described above, in the case where this structural example is applied to a display panel which realizes a full color display, for example, using respective organic materials which can emit light of respective colors of R (red), G (green), and B (blue) in the light emitting layers in EL elements, differences occur in light emitting efficiencies of the EL elements emitting light of respective colors of R, G, and B. In the above-mentioned display panel which realizes the full color display, it is possible to achieve excellent white balance by separately forming anode side power supply circuits which correspond to respective colors of R, G, and B and by adjusting intervals of the above-described refresh operations, corresponding to the respective light-emitting efficiencies of R, G, and B to correct differences in the light-emitting efficiencies.

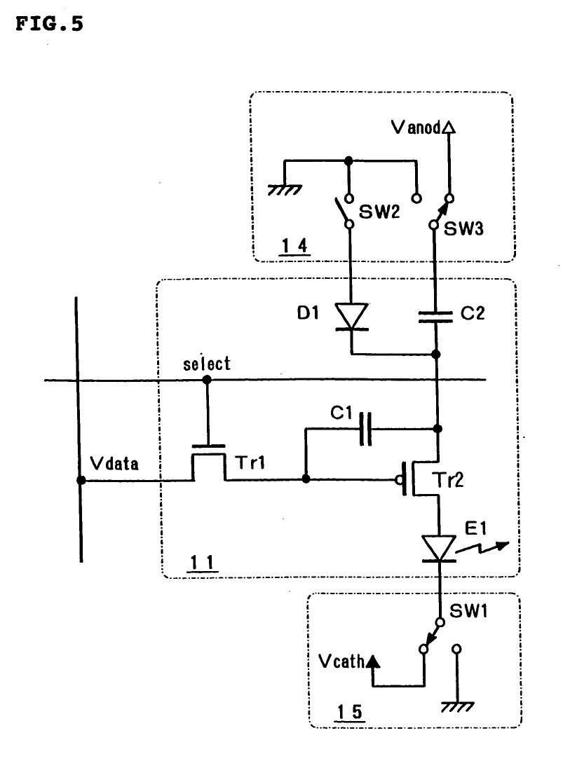

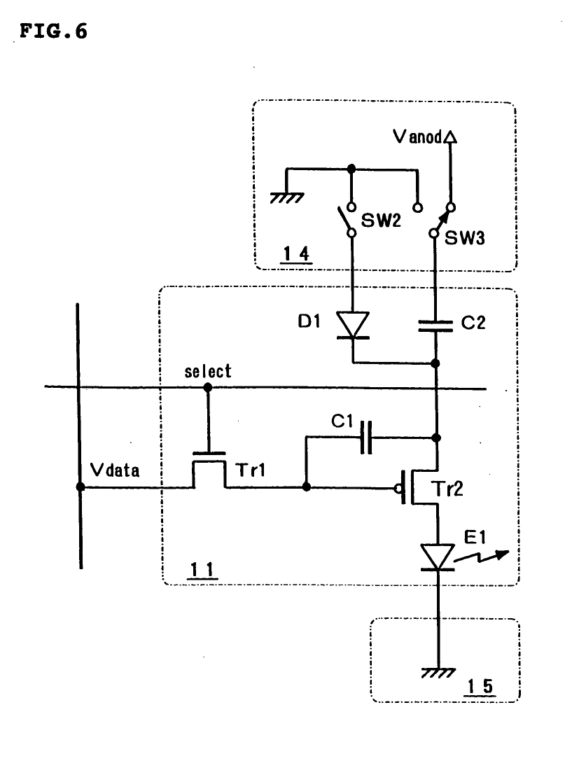

FIG. 5 shows a second embodiment of a driving device including a pixel structure according to the present invention. The structure of a pixel 11 shown in this FIG. 5 is the same as that of the pixel 11 shown in FIG. 2 which has been already explained, and therefore explanation thereof will be omitted. In FIG. 5, respective portions which function similarly to the respective portions shown in FIG. 2 explained above are designated by like reference numerals.

In the structure shown in this FIG. 5, a change-over switch SW3 is provided in an anode side power supply circuit 14 so that the voltage source Vanod or the reference potential (ground potential) can be alternatively applied to one end of the light emitting power holding capacitor C2. The switching element SW2 is constructed in such a manner that the anode of the diode D1 as a unidirectional element can be fallen to the ground potential by turning the switching element SW2 on. The change-over switch SW1 provided in a cathode side power source circuit 15 is, on the other hand, constructed so that the cathode side of the EL element E1 can be connected alternatively to the ground potential or the voltage source Vcath.

Operation circumstances in a refresh operation time of the switching element SW2 and the change-over switch SW3 provided in the anode side power supply circuit 14 and the change-over switch SW1 provided in the cathode side power supply circuit 15 will be explained. That is, at time t1 shown in FIG. 3 (I), the light-emitting potential is switched to the non-light-emitting potential. This is achieved since functionally the change-over switch SW1 provided in the cathode side power supply circuit 15 is switched from the selection state of Vcath to the ground potential and at the same time the change-over switch SW3 provided in the anode side power supply circuit 14 is switched from the selection state of Vanod to the ground potential. By this operation, both end voltages of the EL element E1 become approximately zero, and the EL element E1 is brought into the non-lighting state.

Then, at time t2 as shown in FIG. 3(H), the ON operation of the switching element SW2 is performed. Thus, a refresh operation in which electrical charges of the light emitting power holding capacitor C2 are allowed to be approximately zero via the switching element SW2 and the diode D1 is performed. Then, the OFF operation of the switching element SW2 is performed at time t3 as shown in FIG. 3(H), and the switching element SW2 is switched to a state of the light emitting potential at time t4 immediately thereafter as shown in FIG. 3(I). That is, the change-over switches SW1 and SW3 return to the state shown in FIG. 5.

Thus, the forward voltage between the power source Vanod and the power source Vcath is applied to the series circuit of the capacitor C2, driving TFT (Tr2), and EL element E1. Accordingly, the forward current can flow in the EL element E1 via the capacitor C2 whose electrical charges are in the approximately zero state. At this time if the gate voltage of the driving TFT (Tr2) is in the ON state, the forward current flows in the EL element E1, so that the EL element E1 is brought into the lighting state.

In the embodiment shown in FIG. 5, by suitably setting the number of times of refreshing, N, the gradation of the pixel 11 can be controlled digitally. Current flowing in the EL element E1 is the lighting driving current which attenuates according to the quadratic curve as shown in FIG. 3(E) as has been explained already, and by adopting a voltage waveform which sweeps as shown in FIG. 3(F) as an output voltage supplied from the voltage source Vanod in the anode side power supply circuit 14, it can be prevented similarly that the driving current including a peak value of a high level is supplied to the EL element E1.

In the second embodiment shown in FIG. 5, also, since the driving TFT (Tr2) can be operated in a nonlinear region, it can be prevented that due to variations in threshold voltages (Vth) of driving TFTs, similar variations are imparted to the driving currents, and a problem that nonuniformity in intensity among pixels occurs can be effectively prevented. Thus, respective technical problems which occur in the respective constant voltage driving and constant current driving which have been explained in the section of the prior art can be solved.

FIG. 6 shows a third embodiment of a driving device including a pixel structure according to the present invention. The structure of a pixel 11 shown in this FIG. 6 is the same as that of the pixel 11 shown in FIG. 2 which has been already explained, and therefore explanation thereof will be omitted. In FIG. 6, respective portions which function similarly to the respective portions shown in FIG. 2 explained above are designated by like reference numerals.

In the structure shown in this FIG. 6, the change-over switch SW3 is provided in an anode side power supply circuit 14 so that the voltage source Vanod or the reference potential (ground potential) can be alternatively applied to one end of the light emitting power holding capacitor C2. The switching element SW2 is constructed in such a manner that the anode of the diode D1 as a unidirectional element can be fallen to the ground potential by turning the switching element SW2 on. In the structure shown in this FIG. 6, on the other hand, a cathode side power supply circuit 15 is constructed in such a manner that the cathode side of the EL element E1 is connected to the ground potential.

Operation circumstances in a refresh operation time of the switching element SW2 and the change-over switch SW3 provided in the anode side power supply circuit 14 will be explained. That is, at time t1 shown in FIG. 3 (I), the light-emitting potential is switched to the non-light-emitting potential. This is achieved since functionally the change-over switch SW3 provided in the anode side power supply circuit 14 is switched from the selection state of Vanod (light emitting potential) to the ground potential. By this operation, both end voltages of the EL element E1 become approximately zero, and the EL element E1 is brought into the non-lighting state.

Then, at time t2 as shown in FIG. 3(H), the ON operation of the switching element SW2 is performed. Thus, a refresh operation in which electrical charges of the light emitting power holding capacitor C2 are allowed to be approximately zero via the switching element SW2 and the diode D1 is performed. Then, the OFF operation of the switching element SW2 is performed at time t3 as shown in FIG. 3(H), and the switching element SW2 is switched to the state of the light emitting potential at time t4 immediately thereafter as shown in FIG. 3(I). That is, the change-over switch SW3 returns to the state shown in FIG. 6.

Thus, the forward voltage of the power source Vanod is applied to the series circuit of the capacitor C2, driving TFT (Tr2), and EL element E1. Accordingly, the forward current can flow in the EL element E1 via the capacitor C2 whose electrical charges are in the approximately zero state. At this time, if the gate voltage of the driving TFT (Tr2) is in the ON state, the forward current flows in the EL element E1 so that the EL element E1 is brought into the lighting state.

In the embodiment shown in FIG. 6, also, by suitably setting the number of times of refreshing, N, the gradation of the pixel 11 may be controlled digitally. Current flowing in the EL element E1 is the lighting driving current which attenuates according to a quadratic curve as shown in FIG. 3(E) as has been explained already, and by adopting a voltage wave form which sweeps as shown in FIG. 3(F) as an output voltage supplied from the voltage source Vanod in the anode side power supply circuit 14, it can be prevented similarly that the driving current including a peak value of a high level is supplied to the EL element E1.

In the third embodiment shown in FIG. 6, also, since the driving TFT (Tr2) can be operated in a nonlinear region, it can be prevented that due to variations in threshold voltages (Vth) of driving TFTS, similar variations are imparted to the driving current, and the problem that nonuniformity in intensity among pixels occurs can be effectively prevented. Thus, respective technical problems which occur in the respective constant voltage driving and constant current driving which have been explained in the section of the prior art can be solved.

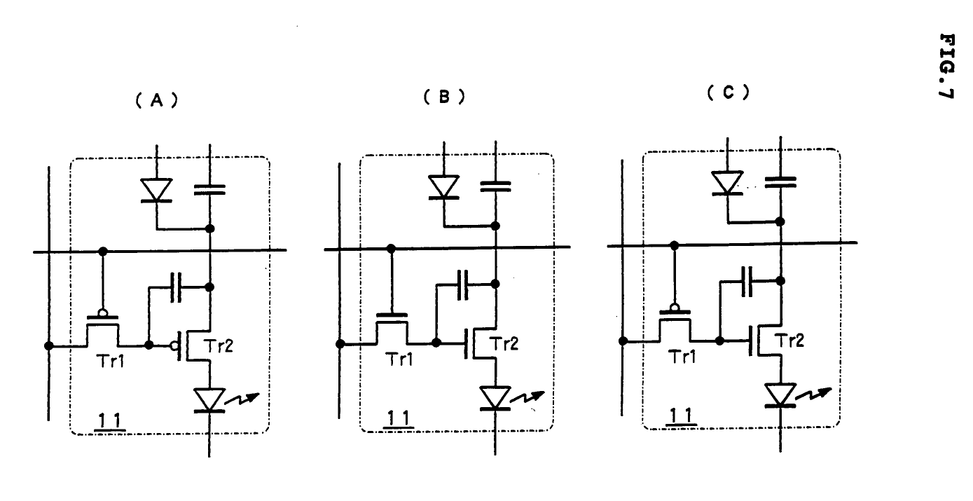

In the respective embodiments explained above, although an N-channel type is employed as the controlling TFT (Tr1) constituting the pixel 11 and a P-channel type is employed as the driving TFT (Tr2), a combination of the controlling TFT and the driving TFT is not limited to this relationship. For example, as shown in FIG. 7(A), a P-channel type can be employed for both of the controlling TFT (Tr1) and the driving TFT (Tr2). As shown in FIG. 7(B), an N-channel type can also be employed for both of the controlling TFT (Tr1) and the driving TFT (Tr2). Further, the present invention can be applied to a structure in which a P-channel type is employed as the controlling TFT (Tr1) and an N-channel type is employed as the driving TFT (Tr2), as shown in FIG. 7(C).

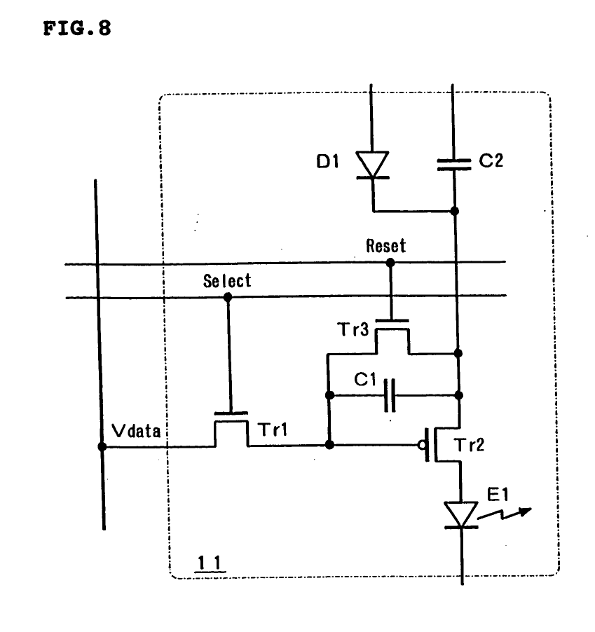

In any one of the embodiments explained above, although a conductance control technique in which two TFTs are provided in one pixel is adopted, the present invention can be applied to a driving technique, for example, in which digital gradation is implemented by three TFTs as shown in FIG. 8. In the structure shown in this FIG. 8, an erasing TFT (Tr3) is provided in addition to a pixel structure by a conductance control technique which has been explained already, and a source and a drain of the TFT (Tr3) are connected to both ends of the electrical charge accumulating capacitor C1. A reset signal is supplied to a gate of the erasing TFT (Tr3) via a control line.

With this structure, in the middle of a lighting period of the EL element E1, the reset signal is given to the gate of the erasing TFT (Tr3) to allow the erasing TFT to perform an ON operation so that electrical charges of the capacitor C1 can be discharged. Accordingly, the lighting period of the EL element E1 can be controlled, and utilizing the erasing TFT (Tr3) enables gradation expression digitally. Even when the present invention is applied to a digital gradation driving technique by such three TFTS, respective technical problems which occur in the respective constant voltage driving and constant current driving which have been already explained can be solved.

A driving device of a light emitting display panel according to the present invention can be suitably utilized in a display panel provided with a light emitting pixel by the above-described two TFTs structure or three TFTs structure. However, the present invention can also be applied to a pixel structure in which a lighting driving means by a structure of three or more TFTs is adopted, for example, for the above-mentioned voltage writing technique, current writing technique, current mirror technique, or the like. This case also can contribute to dissolving of respective technical problems which occur in the respective constant voltage driving or constant current driving which have been explained already.

What is claimed is:

1. A driving device driving an active type light emitting display panel in which a large number of light emitting pixels are arranged, said light emitting pixel being comprised of at least a light emitting element and a driving TFT which lights and drives the light emitting element,
wherein said driving device of the light emitting display panel comprises a power supply means for supplying light emitting driving power to the light emitting element by executing charge and discharge operations for a light emitting power holding capacitor.

2. The driving device of the light emitting display panel according to claim 1 being constructed in such a manner that one or more charge and discharge operations are executed for the light emitting power holding capacitor constituting the power supply means during a light emission driving time of the light emitting element for each scan.

3. The driving device of the light emitting display panel according to claim 1 or 2, wherein a unidirectional element for charging electrical charges in the light emitting power holding capacitor and a switching element supplying current to the unidirectional element are provided in the power supply means.

4. The driving device of the light emitting display panel according to claim 3, wherein at least the respective light emitting power holding capacitor and unidirectional element for charging electrical charges which constitute the power supply means are provided in the light emitting pixel including the light emitting element and the driving TFT.

5. The driving device of the light emitting display panel according to claim 1 or 2, wherein the driving TFT which lights and drives the light emitting element is constructed so as to operate in a nonlinear region.

6. The driving device of the light emitting display panel according to claim 4, wherein the driving TFT which lights and drives the light emitting element is constructed so as to operate in a nonlinear region.

7. The driving device of the light emitting display panel according to claim 1 or 2 being constructed so as to sweep a supply voltage to the light emitting power holding capacitor in synchronization with the charge and discharge operations for the light emitting power holding capacitor.

8. The active type light emitting display device according to claim 1, wherein the light emitting element is constituted by an organic EL element in which an organic compound is employed in a light emitting layer thereof.

9. The active type light emitting display device according to claim 2, wherein the light emitting element is constituted by an organic EL element in which an organic compound is employed in a light emitting layer thereof.

10. The active type light emitting display device according to claim 3, wherein the light emitting element is constituted by an organic EL element in which an organic compound is employed in a light emitting layer thereof.

11. The active type light emitting display device according to claim 4, wherein the light emitting element is constituted by an organic EL element in which an organic compound is employed in a light emitting layer thereof.

12. The active type light emitting display device according to claim 5, wherein the light emitting element is constituted by an organic EL element in which an organic compound is employed in a light emitting layer thereof.

13. The active type light emitting display device according to claim 6, wherein the light emitting element is constituted by an organic EL element in which an organic compound is employed in a light emitting layer thereof.

14. The active type light emitting display device according to claim 7, wherein the light emitting element is constituted by an organic EL element in which an organic compound is employed in a light emitting layer thereof.
